(19) United States
(12) Patent Application Publication
(10) Pub. No.: US 2026/0287871 A1
(43) Pub. Date: Sep. 24, 2026

(54) METHOD, DEVICE AND MEDIUM FOR STEP SIZE CALIBRATION OF TWO-DIMENSIONAL SCANNING MODULE IN SCANNING LIGHT FIELD IMAGING SYSTEM

(71) Applicant: ZHEJIANG HEHU TECHNOLOGY CO., LTD., HANGZHOU (CN)

(72) Inventor: YI YANG, HANGZHOU (CN)

(21) Appl. No.: 19/355,637

(22) Filed: Oct. 10, 2025

(30) Foreign Application Priority Data
Mar. 19, 2025 (CN) 202510322359.9

(51) Int. Cl. G02B 21/00; G02B 21/36

(52) U.S. Cl. CPC G02B 21/0036; G02B 21/0032; G02B 21/367

(57) ABSTRACT

A method, device and medium for step size calibration of a two-dimensional scanning module in a scanning light field imaging system are provided. The method includes: collecting the two-dimensional raw scanning light field data at the initial scanning step size, and rearranging into four-dimensional phase space data to obtain multi-view rearranged images; selecting the middle views of all views in the multi-view rearranged images to obtain non-scanned central view sub-images; calculating the sub-pixel displacement matrix of all non-scanned central view sub-images relative to the first non-scanned central view sub-image; calculating the average displacement quantity according to the sub-pixel displacement matrix, and calculating the step size adjustment coefficient according to the average displacement quantity; and updating the correct scanning step size according to the step size adjustment coefficient.

### CROSS REFERENCE TO RELATED APPLICATIONS

The present disclosure claims the priority to the Chinese patent application with the filing No. 202510322359.9, entitled “METHOD, DEVICE AND MEDIUM FOR STEP SIZE CALIBRATION OF TWO-DIMENSIONAL SCANNING MODULE IN SCANNING LIGHT FIELD IMAGING SYSTEM” and filed on Mar. 19, 2025 with the Chinese Patent Office, the contents of which are incorporated herein by reference in their entirety.

### TECHNICAL FIELD

The present disclosure relates to the technical field of light field microscopic imaging, and more particularly to a method, device, and medium for step size calibration of a two-dimensional scanning module in a scanning light field imaging system.

### BACKGROUND ART

In the light field microscopic imaging systems, multi-view light field imaging is achieved by using microlenses, and a certain amount of spatial resolution is sacrificed so as to obtain angular information about the light rays. Phase-space reconstruction methods may then be used to obtain three-dimensional tomographic results of the sample. To improve the lateral resolution of the light field microscopic imaging systems while maintaining angular resolution, a two-dimensional galvanometer is added to scan the sample in two dimensions, achieving spatiotemporal multiplexing of scanning imaging. By stitching the images obtained from multiple scans according to the scan positions, images with higher spatial resolution can be obtained.

Taking a 3×3 scan as an example, the scanning step size must be strictly controlled to ⅓ of the physical size of a single microlens to effectively improve the resolution of the stitched scanned images. A step size that is too large may result in data redundancy and failure in improving resolution; and a step size that is too small may result in discontinuous stitched images. Therefore, achieving the optimal scanning step size is crucial for improving the spatial resolution of scanning light field imaging.

Therefore, how to provide a method for step size calibration of a two-dimensional scanning module in a scanning light field imaging system is an urgent problem that needs to be solved by those skilled in the art.

### SUMMARY

In view of this, the present disclosure provides a method, device, and medium for step size calibration of a two-dimensional scanning module in a scanning light field imaging system, which may realize the calibration of the scanning step size for two-dimensional scanning imaging with faster speed and higher precision, thereby improving the spatial resolution of scanning imaging.

In order to achieve the above purpose, the present disclosure adopts the following technical solutions.

A method for step size calibration of a two-dimensional scanning module in a scanning light field imaging system includes:
collecting the two-dimensional raw scanning light field data at the initial scanning step size, and rearranging into four-dimensional phase space data to obtain multi-view rearranged images;
selecting the middle views of all views in the multi-view rearranged images to obtain non-scanned central view sub-images;
calculating the sub-pixel displacement matrix of all non-scanned central view sub-images relative to the first non-scanned central view sub-image;
calculating the average displacement quantity according to the sub-pixel displacement matrix, and calculating the step size adjustment coefficient according to the average displacement quantity; and
updating the correct scanning step size according to the step size adjustment coefficient.

Preferably, the calculating the sub-pixel displacement matrix of all non-scanned central view sub-images relative to the first non-scanned central view sub-image specifically includes:
calculating the cross-correlations between all non-scanned central view sub-images and the first non-scanned central view sub-image respectively, where the maximum value of the cross-correlations is the relative displacement of two images;

$${C}_{i , j} ( m , n ) = {\sum }_{x} {\sum }_{y} CV ( i , j , x + m , y + n ) CV ( 1 , 1 , x , y ) , y ∈ [ 1 , h ] , x ∈ [ 1 , w ]$$

$$s ( i , j ) = arg max {C}_{i , j} ( m , n ) , i ∈ [ 1 , N ] , j ∈ [ 1 , N ]$$

where i and j indicate the coordinates of the two-dimensional scan, N indicates the number of scans; x and y indicate the two-dimensional pixel coordinates of the image, m and n indicate the two-dimensional cross-correlation calculation variables; h and w indicate the pixel height and pixel width of the multi-view rearranged image, CV(·) indicates the non-scanned central view sub-image, and s(i, j) indicates the sub-pixel displacement matrix.

Preferably, the average displacement quantity in the X-axis direction is:

$$X = \frac{S [ N , : , 1 ] - S [ 1 , : , 1 ]}{N ( N - 1 )}$$

where S[N,:,1] indicates the x displacement of the N-th column of the sub-pixel displacement matrix, S[1,:,1] indicates the x displacement of the 1st column of the sub-pixel displacement matrix;
the average displacement quantity in the Y-axis direction is:

$$Y = \frac{S [ : , N , 2 ] - S [ : , 1 , 2 ]}{N ( N - 1 )}$$

where S[:,N,2] indicates the y displacement of the N-th row of the sub-pixel displacement matrix, S[:,1,2] indicates the y displacement of the 1st row of the sub-pixel displacement matrix;
the step size adjustment coefficient KX in the X-axis direction is:

$$KX = \frac{1}{N * X}$$

where X indicates the average displacement quantity in the X-axis direction; and
the step size adjustment coefficient KY in the Y-axis direction is:

$$KY = \frac{1}{N * Y}$$

where Y indicates the average displacement quantity in the Y-axis direction.

Preferably, the correct scanning step sizes are:

$$SX = VX * KX$$

$$SY = VY * KY$$

where SX indicates the correct scanning step size in the X-axis direction, SY indicates the correct scanning step size in the Y-axis direction, VX indicates the initial scanning step size in the X-axis direction, and VY indicates the initial scanning step size in the Y-axis direction.

A computer device includes: a memory and a processor, where the memory stores a computer program that may be run on the processor, and when the processor executes the computer program, a method for step size calibration of a two-dimensional scanning module in a scanning light field imaging system is implemented.

A computer-readable storage medium on which a computer program is stored. When the computer program is executed by a processor, a method for step size calibration of a two-dimensional scanning module in a scanning light field imaging system is implemented.

It may be seen from the above technical solutions that compared with the prior art, the present disclosure discloses a method, device and medium for step size calibration of a two-dimensional scanning module in a scanning light field imaging system. The sub-pixel position offsets between multiple scanned images are calculated by using a sub-pixel registration method, and the optimal scanning step size is adjusted according to the calculation results to achieve the highest spatial resolution.

### BRIEF DESCRIPTION OF DRAWINGS

In order to more clearly illustrate the technical solutions in the embodiments of the present disclosure or in the prior art, the drawings required for use in the description of embodiments or the prior art will be briefly introduced below. Obviously, the drawings described below are only embodiments of the present disclosure. For a person ordinarily skilled in the art, other drawings may be obtained based on the provided drawings without paying creative work.

FIG. 1 is a flow chart of a method for step size calibration of a two-dimensional scanning module in a scanning light field imaging system provided by the present disclosure.

FIG. 2 shows displacement matrixes of a scanned image in the cases where the step size of the two-dimensional scanning module provided by the present disclosure is incorrect and correct.

FIG. 3 shows the imaging effects of a scanned image in the cases where the step size of the two-dimensional scanning module provided by the present disclosure is too small, too large, and correct.

### DETAILED DESCRIPTION OF EMBODIMENTS

The technical solutions in the embodiments of the present disclosure will be clearly and completely described below in conjunction with the drawings in the embodiments of the present disclosure. Obviously, the described examples are only some of the embodiments of the present disclosure, not all of the embodiments. Based on the embodiments of the present disclosure, all other embodiments obtained by a person ordinarily skilled in the art without creative work fall within the scope of protection of the present disclosure.

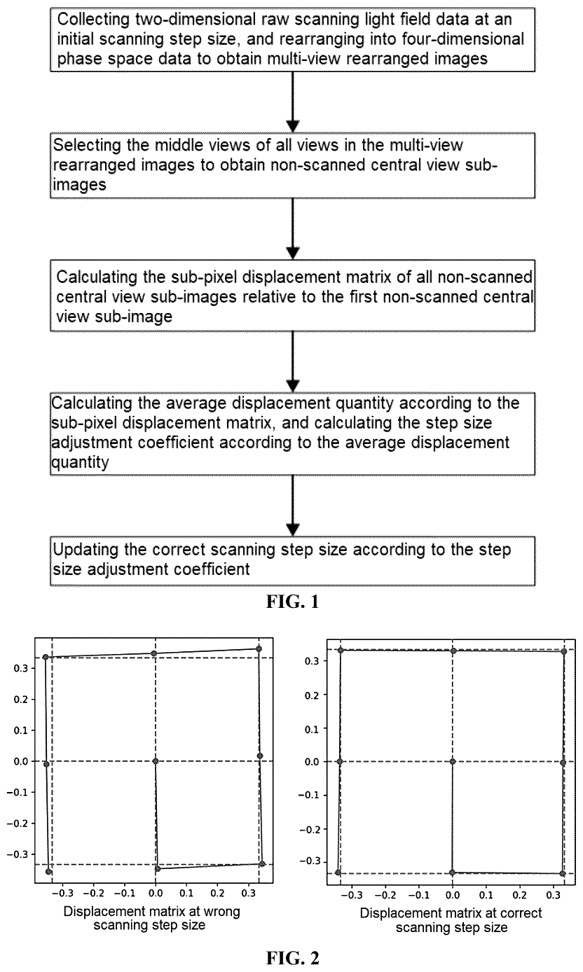

An embodiment of the present disclosure discloses a method for step size calibration of a two-dimensional scanning module in a scanning light field imaging system, as shown in FIG. 1, including:
collecting the two-dimensional raw scanning light field data at the initial scanning step size, and rearranging into four-dimensional phase space data to obtain multi-view rearranged images;
selecting the middle views of all views in the multi-view rearranged images to obtain non-scanned central view sub-images;
calculating the sub-pixel displacement matrix of all non-scanned central view sub-images relative to the first non-scanned central view sub-image;
calculating the average displacement quantity between scanned images according to the sub-pixel displacement matrix, and calculating the scanning step size adjustment coefficient according to the average displacement quantity; and
setting the minimum threshold and maximum threshold for terminating iterations, and updating the scanning step size according to the step size adjustment coefficient.

If the step size adjustment coefficient is greater than the maximum threshold or less than the minimum threshold, the scanning step size is updated and the collection, calibration and updating steps are repeated; and if the step size adjustment coefficient is greater than the minimum threshold and less than the maximum threshold, the updating is stopped to obtain the correct scanning step size.

The scanning light field imaging system includes, but not limited to, a scanning light field imaging system based on a microlens array, and a scanning light field imaging system based on a camera array. The present disclosure takes a scanning light field microscope system based on a microlens as an embodiment. The steps of the present disclosure are described in detail below. In the scanning light field microscopic imaging system, a two-dimensional galvanometer scanning module is added to perform two-dimensional scanning on the sample to be measured, to improve the spatial resolution. The two-dimensional galvanometer module realizes scanning imaging through two parameters: scanning step sizes of VX, VY and the number of scans of N. Taking N*N scanning as an example, that is, the number of two-dimensional scans, including N horizontal scans, N vertical scans, and a total of N*N scans, the current scanning step sizes are known to be VX and VY respectively, and a N² sheets of two-dimensional raw scanning light field data is collected. Optionally, a two-dimensional serpentine scanning path is used to reduce mechanical return errors. In specific implementation, the horizontal scanning direction is reversed in the even-numbered rows to form a continuous motion trajectory.

The two-dimensional raw scanning light field data is rearranged into four-dimensional phase space data, including the following specific steps: rearranging N² sheets of the two-dimensional raw scanning light field data to obtain N multi-view rearranged images with the shape of u*v*h*w, where u and v are the index coordinates of the horizontal and vertical views of the multi-view rearranged image, and h and w are the pixel height and pixel width of each multi-view rearranged image, respectively. Specifically, the vertical and horizontal dimensions of the two-dimensional light field image are u*h and v*w, respectively. For the index coordinate of a fixed view, the pixel values at different spatial coordinates are obtained for the view coordinate to form a spatial coordinate sub-image for the view coordinate; and the spatial coordinate sub-images for all view coordinates are sequentially arranged to collectively form the four-dimensional phase space light field data of the two-dimensional light field image.

The obtain non-scanned central view sub-images includes the following specific steps: selecting the middle view of all views in each multi-view rearranged image, that is, the sub-view image at the u/2-th in the horizontal direction and the v/2-th in the vertical direction, to obtain N² non-scanned central view sub-images CV with a shape of N*N*h*w. The cross-correlation is used to calculate the sub-pixel displacement matrix S with a shape of N*N*2 of each of the N non-scanned central view sub-images relative to the first non-scanned central view sub-image, where the sub-pixel displacement matrix characterizes the pixel offsets between images caused by two-dimensional scanning. Cross-correlation is used to calculate the pixel offset between image values, including the following specific steps: calculating the cross-correlation between each of the N non-scanned central view sub-images and the first non-scanned central view sub-image, where the maximum value of the cross-correlations is the relative displacement between the two images:

$${C}_{i , j} ( m , n ) = {\sum }_{x} {\sum }_{y} CV ( i , j , x + m , y + n ) CV ( 1 , 1 , x , y ) , y ∈ [ 1 , h ] , x ∈ [ 1 , w ]$$

$$s ( i , j ) = arg max {C}_{i , j} ( m , n ) , i ∈ [ 1 , N ] , j ∈ [ 1 , N ]$$

where i and j indicate the coordinates of the two-dimensional scan, N indicates the number of scans; x and y indicate the two-dimensional pixel coordinates of the image, m and n indicate the two-dimensional cross-correlation calculation variables; h and w indicate the pixel height and pixel width of the multi-view rearranged image, CV(·) indicates the non-scanned central view sub-image, and s(i,j) indicates the sub-pixel displacement matrix.

Optionally, bicubic interpolation is performed on a 5*5 pixel area around the cross-correlation integer pixel peak to improve the accuracy of calculating the sub-pixel displacement matrix.

The step size adjustment coefficients KX and KY are calculated, including the following specific steps: calculating the average displacement quantities X and Y and step size adjustment coefficients KX and KY according to the sub-pixel displacement matrix S:

$$Y = \frac{S [ : , N , 2 ] - S [ : , 1 , 2 ]}{N ( N - 1 )}$$

$$KY = \frac{1}{N * Y}$$

where S[:,N,2] indicates the y displacement of the N-th row of the sub-pixel displacement matrix, and S[:,1,2] indicates the y displacement of the 1st row of the sub-pixel displacement matrix; where N corresponds to the N*N non-scanned central view sub-images, i.e., for a total of N*N non-scanned central view sub-images, the first two dimensions of the corresponding sub-pixel displacement matrix are N*N;

$$X = \frac{S [ N , : , 1 ] - S [ 1 , : , 1 ]}{N ( N - 1 )}$$

$$KX = \frac{1}{N * X}$$

where S[N,:,1] indicates the x displacement of the N-th column of the sub-pixel displacement matrix, and S[1,:,1] indicates the x displacement of the 1st column of the sub-pixel displacement matrix.

It should be noted that the sub-pixel displacement matrix between the two images characterizes the displacements of corresponding pixels of the two images in the horizontal direction and the vertical direction. Due to issues such as a displacement stage accuracy, return error, and algorithm calculation accuracy, the scanning step sizes vary between different scanning positions. Taking the average of the displacements across all scanning positions may reduce errors.

The minimum threshold for terminating iterations is set to 0.9 and the maximum threshold to 1.1, and the scanning step size is updated according to the step size adjustment coefficient. If the step size adjustment coefficient is greater than the maximum threshold or less than the minimum threshold, the scanning step size is updated, and the collection, calibration and updating steps are repeated; and if the step size adjustment coefficient is greater than the minimum threshold and less than the maximum threshold, the updating is stopped to obtain the correct scanning step size.

$$SX = VX * KX$$

$$SY = VY * KY$$

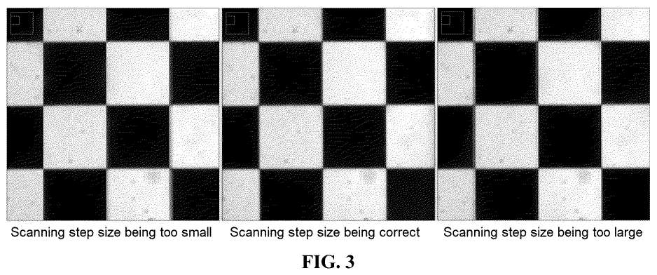

In FIG. 2, the left figure shows that when the scanning step size is incorrect, the displacement matrix (solid line) deviates greatly from the standard displacement matrix (dashed line); and the right figure shows that when the method converges, the correct displacement matrix (solid line) and the standard displacement matrix (dashed line) coincide well.

FIG. 3 shows, from left to right, the scanning imaging results when the scanning step size is too small, correct, and too large. When the scanning step size is too small or too large, scanning artifacts may be generated at the edge of the sample to be measured, while when the scanning step size is correct, the edge of the sample to be measured is relatively sharp.

This embodiment provides a computer device, including: a memory and a processor. The memory stores a computer program that may be run on the processor. When the processor executes the computer program, a method for step size calibration of a two-dimensional scanning module in a scanning light field imaging system is implemented.

This embodiment provides a computer-readable storage medium having a computer program stored thereon. When the computer program is executed by a processor, a method for step size calibration of a two-dimensional scanning module in a scanning light field imaging system is implemented.

Those skilled in the art may appreciate that all or some of the steps of the above-mentioned method embodiments may be implemented by hardware associated with program instructions. The aforementioned program may be stored in a computer-readable storage medium. When the program is executed, the steps of the above-mentioned method embodiments are executed. The aforementioned storage medium includes various media that may store program codes, such as mobile storage device, read-only memory (ROM), random access memory (RAM), magnetic disk, or optical disk.

In this specification, the embodiments are described in a progressive manner, and each embodiment focuses on the differences from other embodiments. The same or similar parts between the embodiments may be referred to each other. For the device disclosed in the embodiment, since it corresponds to the method disclosed in the embodiment, the description is relatively simple, and the relevant parts can be referred to the method parts.

The above description of the disclosed embodiments enables one skilled in the art to implement or use the present disclosure. Various modifications to these embodiments will be apparent to one skilled in the art, and the general principles defined herein may be implemented in other embodiments without departing from the spirit or scope of the present disclosure. Therefore, the present disclosure will not be limited to the embodiments shown herein, but rather will conform to the widest scope consistent with the principles and novel features disclosed herein.

1. A method for step size calibration of a two-dimensional scanning module in a scanning light field imaging system, comprising:
performing two-dimensional scanning on a sample to be measured, with N scans in a horizontal direction and N scans in a vertical direction, totaling N*N scans, collecting N² sheets of two-dimensional raw scanning light field data, and rearranging into four-dimensional phase space data to obtain multi-view rearranged images;
selecting middle views of all views in the multi-view rearranged images to obtain non-scanned central view sub-images;
calculating a sub-pixel displacement matrix of all non-scanned central view sub-images relative to a first non-scanned central view sub-image, where the sub-pixel displacement matrix characterizes pixel offsets between images caused by two-dimensional scanning;
calculating an average displacement quantity according to the sub-pixel displacement matrix, and calculating a step size adjustment coefficient according to the average displacement quantity; and
updating a correct scanning step size according to the step size adjustment coefficient;
wherein the calculating the sub-pixel displacement matrix of all non-scanned central view sub-images relative to the first non-scanned central view sub-image specifically comprises:
calculating cross-correlations between all of the non-scanned central view sub-images and the first non-scanned central view sub-image respectively, wherein a maximum value of the cross-correlations is a relative displacement of two images;
$${C}_{i , j} ( m , n ) = {\sum }_{x} {\sum }_{y} CV ( i , j , x + m , y + n ) CV ( 1 , 1 , x , y ) , y ∈ [ 1 , h ] , x ∈ [ 1 , w ]$$
$$s ( i , j ) = argmax {C}_{i , j} ( m , n ) , i ∈ [ 1 , N ] , j ∈ [ 1 , N ]$$
wherein i and j indicate coordinates of the two-dimensional scanning, N indicates number of scans; x and y indicate two-dimensional pixel coordinates of an image, m and n indicate two-dimensional cross-correlation calculation variables; h and w indicate a pixel height and pixel width of the multi-view rearranged image, CV(·) indicates the non-scanned central view sub-image, and S(i, j) indicates the sub-pixel displacement matrix;
an average displacement quantity in an X-axis direction is:
$$X = \frac{S [ N , : , 1 ] - S [ 1 , : , 1 ]}{N ( N - 1 )}$$
wherein S[N,:,1] indicates an x displacement of a N-th column of the sub-pixel displacement matrix, S[1,:,1] indicates an x displacement of a 1st column of the sub-pixel displacement matrix;
an average displacement quantity in a Y-axis direction is:
$$Y = \frac{S [ : , N , 2 ] - S [ : , 1 , 2 ]}{N ( N - 1 )}$$
wherein S[:,N,2] indicates a y displacement of a N-th row of the sub-pixel displacement matrix, S[:,1,2] indicates the y displacement of a 1st row of the sub-pixel displacement matrix;
a step size adjustment coefficient KX in the X-axis direction is:
$$KX = \frac{1}{N * X}$$
wherein X indicates the average displacement quantity in the X-axis direction; and
a step size adjustment coefficient KY in the Y-axis direction is:
$$KY = \frac{1}{N * Y}$$
wherein Y indicates the average displacement quantity in the Y-axis direction.

2. The method for step size calibration of a two-dimensional scanning module in a scanning light field imaging system according to claim 1, wherein correct scanning step sizes are:
$$SX = VX * KX$$
$$SY = VY * KY$$
wherein, SX indicates a correct scanning step size in the X-axis direction, SY indicates a correct scanning step size in the Y-axis direction, VX indicates an initial scanning step size in the X-axis direction, and VY indicates the initial scanning step size in the Y-axis direction.

3. A computer device, comprising: a memory and a processor, wherein the memory stores a computer program runnable on the processor, and when the processor executes the computer program, the method according to claim 1 is implemented.
